(19) United States
(12) Patent Application Publication
(10) Pub. No.: US 2011/0302802 A1
(43) Pub. Date: Dec. 15, 2011

(54) DUAL FUEL DRYER

(75) Inventors: Joshua S. Wiseman, Elizabethtown, KY (US); Michael F. Finch, Louisville, KY (US); Jerrod Aaron Kappler, Louisville, KY (US); Steven Keith Root, Buckner, KY (US); Chad Helms, Louisville, KY (US); Peter Pepe, Louisville, KY (US)

(73) Assignee: General Electric Company

(21) Appl. No.: 12/797,311

(22) Filed: Jun. 9, 2010

(51) Int. Cl. F26B 3/02; F24C 11/00; F26B 19/00; F26B 25/06

(52) U.S. Cl. 34/493; 34/218; 392/307; 34/553; 34/551

(57) ABSTRACT

A clothes dryer operates on at least one of first and second sources of power or fuel. The clothes dryer has a housing with a drum that receives associated laundry and a blower assembly for selectively circulating air in the drum to dry the laundry. The dryer is configured for connection with an associated first source of fuel/power for a first heater (e.g., electric) and additionally configured for connection with a different type, associated second source of fuel/power for a second heater (e.g., combustible fuel). Typically, the clothes dryer is adapted for both an electrical connection and a combustible fuel connection. A controller receives a signal or data from an external source indicative of price and usage operation of a particular power source. The controller can then provide an output that prompts the consumer for selection of different modes of operation using the first heater, second heater, or a combination of both.

### BACKGROUND OF THE DISCLOSURE

This application relates to a clothes dryer of the type where laundry or garments are inserted into a housing cavity or drum, exposed to heat laden air, and moisture laden air is removed from the cavity. More particularly, this disclosure relates to increased options for hook-up, use, and energy savings capabilities.

Typically, residential clothes dryers are powered by either electricity or a combustible fuel such as natural gas. In some instances, propane or butane may be used instead of natural gas as the combustible fuel. These clothes dryers use either an electric resistance heating element or a combustible fuel source for selectively raising the temperature of air directed into the drum of the dryer.

For example a 110 volt or 220 volt electric dryer directs electrical current through a resistor element or heating element, and a temperature of an airflow is elevated by directing the airflow over the heating element and into the drum where the garments are dried by the combined heat exchange and airflow. The drum is rotated by a motor, and one or more tumbler bars are provided on an inner surface of the drum to circulate the garments and expose different surfaces to the heated airflow. The heated air results in heat transfer with the garments or laundry items, the circulated air become moisture laden, and the air is then removed from the drum and whereby the garments are dried. Heated air can be introduced into the drum for predetermined/preselected time periods, and/or sensors can be employed to monitor the moisture content of the garments, the relative humidity of the heated air, or the temperature in an effort to provide greater control over the drying cycle.

Alternatively, combustible fuel is used as the source of heat. As noted, natural gas is the most common combustible fuel used in domestic dryers for individual households. Although propane and butane are occasionally used, and thus may require a conversion kit to modify the combustible fuel/natural gas dryer to operate on this alternative combustible fuel, the mode of operation is otherwise similar. Further, many of the dryer components and mode of operation of the combustible fuel type of dryer are similar to the electric clothes dryer generally described above.

There is a continuing need to conserve energy, and to operate home appliances in the most efficient manner possible. A large majority of households include both an electrical power supply as well as a combustible fuel supply. The appliances, though, are usually one type or the other. Thus, a need exists for a clothes dryer that can operate on both types of energy sources. Moreover, a need exists for a clothes dryer that can easily switch between alternative sources of energy, and allow the consumer the ability to select the most cost effective fuel/energy type, or alternatively, the more cost efficient choice for operating the clothes dryer.

### SUMMARY OF THE DISCLOSURE

A clothes dryer that operates on at least one of first and second sources of power includes a housing having a cavity for receiving associated laundry. An air assembly selectively circulates air into the cavity for drying the associated laundry. A controller is operatively associated with the air assembly for operative connection with an associated first type of heater source, and additionally configured for operative connection with a different type, associated second heater source.

Preferably, the first heater source is an electrical resistance heater. The second heater source is a combustible fuel heater.

The dryer includes an electrical interface configured for connection with the associated first heater source, and a combustible fuel interface configured with the associated second heater source.

A controller is configured to periodically receive data from an associated first data source external to the dryer regarding costs associated with operation using the electrical heater.

The processor is further configured to receive data from an associated data source external to the dryer regarding costs associated with the combustible fuel heater source.

The processor receives the data and provides selection information of the most economical manner to operate the dryer.

Consumer input is provided in the selection process to select one or the other of the heater types, or alternatively to use both heater fuel sources simultaneously.

A kit can be provided for an existing gas dryer to add electrical heating elements and interconnections, as well as an interface with the controller. Alternatively, and existing electric dryer may include a kit for adding a combustion chamber, gas intake, gas valve, and burner, and associated processor and interface connections.

A primary benefit is the ability to switch from one fuel type to another to dry clothing or garments.

Another benefit is the ability to select a more cost effective manner of drying clothes.

Yet another benefit resides in the ability to convert an existing dryer for one type of fuel to accommodate a second type of heater.

Yet another benefit is associated with receiving a cost data, processing the information, and providing feedback to the consumer in order to make a choice of the desired operation of the clothes dryer.

Still other features and benefits of the disclosure will become more apparent from reading and understanding the following detailed description.

### BRIEF DESCRIPTION OF THE DRAWINGS

FIG. 1 is a perspective view of a dryer.

FIG. 2 is a diagrammatic, cross-sectional view taken through the dryer of FIG. 1.

FIG. 3 is a schematic representation of how the dryer receives information from an external data source.

### DETAILED DESCRIPTION OF THE PREFERRED EMBODIMENTS

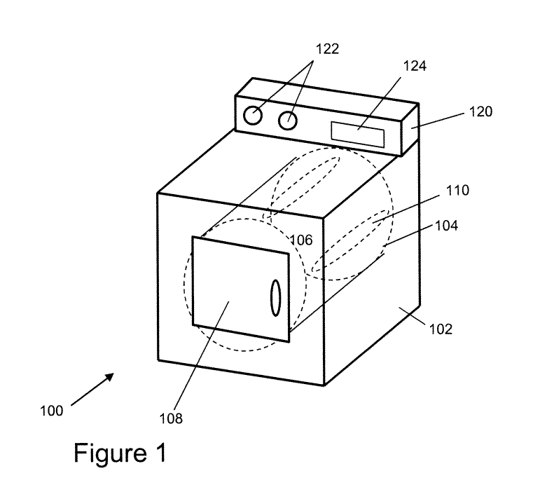

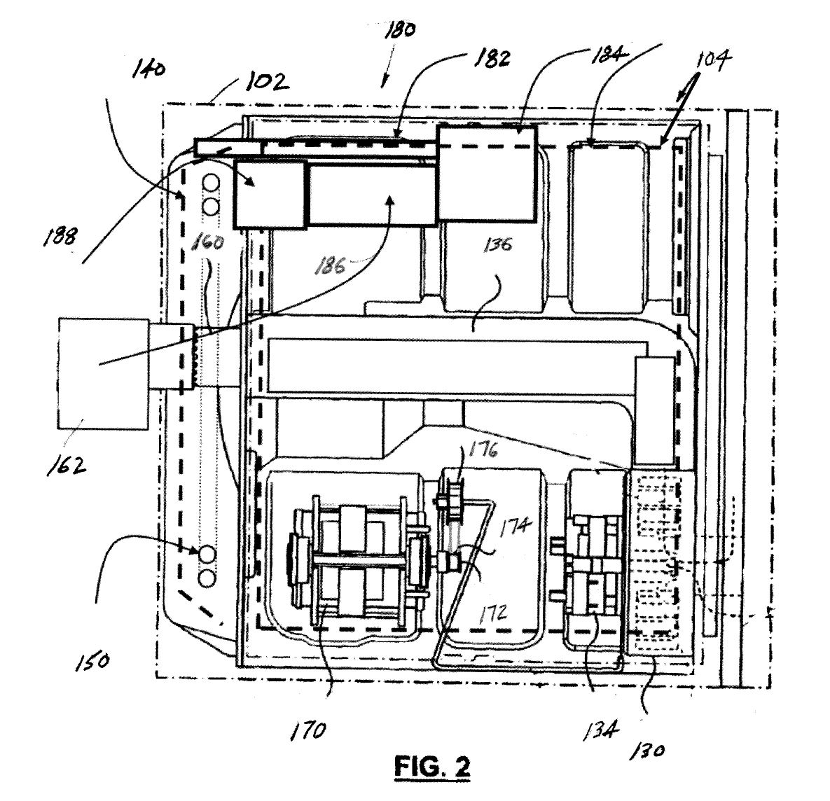

Turning first to FIGS. 1 and 2, a clothes dryer 100 includes a housing 102 in which a drum 104 is mounted for rotation (shown here as rotating about a horizontal axis). Access to an internal cavity 106 of the drum is obtained through a door 108 through a front wall of the housing, for example. The drum typically includes tumbling bars 110 spaced along the inner circumferential portion of the drum to assist in tumbling the laundry or garments (not shown) inserted in the clothes dryer. A control panel 120 includes a user interface such as control knobs 122 or a touch screen, or the like. These are connected to a controller or processor 124 to control temperature, time, relative moisture content, etc. by receiving signals from appropriate sensors (not shown) that communicate among the drum, motor, etc. with the processor and the control inputs 122.

As is well known in the art, air is drawn into the housing via a blower fan 130 that rotates about shaft 132 driven by motor 134 (FIG. 2). Air flows around the heater housing 140 in the back of the dryer over heating elements 150 into the clothes drum 104. A first type of heater includes electric heaters or heater coils 150 received in the heater housing 140 that elevate the temperature of the air delivered from the blower prior to introduction into the drum. One or more heater coils are typically provided so that the desired temperature can be regulated via the controller 124. The heat is transferred to the clothes within the drum, and moisture laden air is then exhausted from the drum, for example through outlet port 160 and external vent 162. During selected portions of a drying cycle, power to the heaters may be varied, or de-actuated so that room temperature air is drawn in from around the dryer housing and flows through the drum while the clothes are tumbled.

Motor 170 includes a driven shaft 172 and drive pulley 174 that cooperate with a belt (not shown) that also extends through idler pulley 176 around the external periphery of the drum. Rotation of the drum is controlled through the motor 170 which communicates with the controller 124.

In addition to the electric heaters 150, the dryer includes a second or different type of heater, which in this exemplary embodiment is a combustible fuel heater 180. As noted in the Background, natural gas is the typical combustible fuel, although propane and butane may be used with equal success. Gas inlet 182 receives the supply of gas from an external source (not shown) and delivers the combustible fuel to gas valve 184. Air and gas are appropriately mixed and then combusted in combustion chamber 186 and delivered through passageway 188 to a rear portion of the drum, i.e., through heater housing 140 that communicates with the drum. Again, air is pulled through the drum by the blower fan 130 around the heater housing where it is suitably heated by either the first or electric heater 150, or the second or combustible fuel heater 180 within the heater housing 140 that communicates with the drum. In still other situations, it is contemplated that heat may be provided by both of the first and second heaters during operation of the clothes dryer.

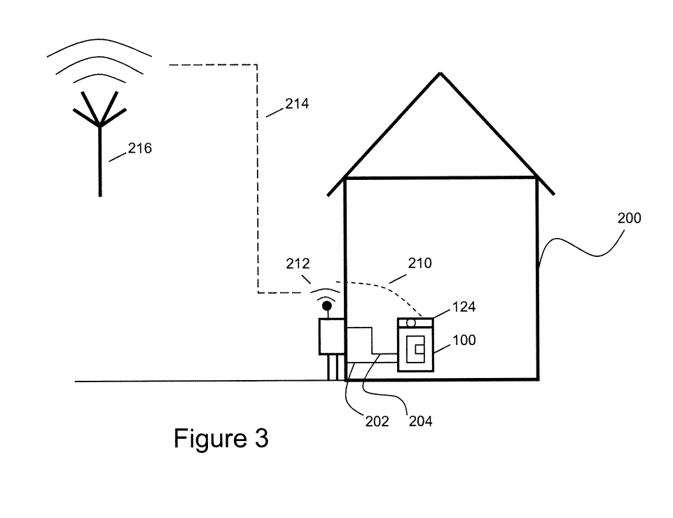

With continued reference to FIGS. 1 and 2, and additional reference to FIG. 3, the clothes dryer 100 is shown in a house 200 where suitable connections 202, 204 to representative electrical and combustible fuel supplies from an external source(s) such as a utility or subdivision proceed into the house for connection or hook-up with the clothes dryer. The electrical connections may comprise, for example, a 110/220 power supply, while the gas supply is typically provided through gas supply line 204 from a tank or riser that connects with the gas supply. These types of connections are well known in the art so that further discussion herein is deemed unnecessary.

In addition, controller 124 is shown as receiving a wired or wireless signal 210 from a module or receiver 212 that, in turn, receives an appropriate signal 214 from emitter or transmitter 216. Although schematically represented as wireless connections, these can also be wired connections that provide for cost and usage data associated with each of the power sources, e.g., electrical cost and gas supply costs that are delivered to the controller 124 of the clothes dryer. In some instances, it is contemplated that these signals may be provided directly from the utilities, although in other instances they may be provided from a housing subdivision or alternative source. Likewise, although the module could be directly connected or mounted to the clothes dryer, it is also contemplated that a module be received external to the housing, or at an internal location in the housing that communicates with one or more appliances within the house. In any event, the cost and usage data or information is communicated to the controller 124 of the clothes dryer. The controller or processor (which oftentimes will include a memory or lookup table) receives the data and calculates the associated costs with operating the clothes dryer on either the electrical power source (i.e., using the first power source or electricity to operate the first type or electric heater), or alternatively by using the combustible fuel source (i.e., using the second power source or combustible fuel to operate the second type combustible fuel heater), or a combination of both the first and second heaters.

Typically, it is envisioned that this cost/operational information will be displayed or communicated to the user/consumer in order for the consumer to select a desired mode of operation of the clothes dryer. Although the clothes dryer could be operated automatically based on the most economical manner of operation, it is preferred that the consumer be permitted to select the particular mode of operation based on the cost/operational data received by the processor and displayed or communicated to the consumer on a user interface display, for example. For example, the most economical manner of operation may be selected, or a time delay selected, or the consumer may opt to ignore the prompted choice and select to operate the clothes dryer in an alternative desired manner.

The particular clothes dryer described and illustrated herein has the dual fuel connections. However, it is also contemplated that a consumer may not choose to hook-up the dryer to one of the different fuel sources. Therefore, an appropriate detection signal may be provided to the controller to evidence that each of the connections 202, 204 have been made, or that only one of the fuel connections has been made so that the controller can provide appropriate data or prompts for the consumer to select the mode of operation.

Likewise, if an existing dryer of one type of heater is in present use in a household, a kit may be supplied to convert the dryer to a second, different type of heater can be supplied along with the appropriate controller/software to accommodate such a situation. For example, a kit for modifying an existing gas dryer may add the electrical connection for a 110 or 220 volt hook-up along with connecting to the processor and/or interface along with adding heating elements or coils to the dryer. Likewise, a kit for modifying an existing electric clothes dryer may add a combustion chamber, gas intake, gas valve etc. to the electric dryer, along with suitable interconnections with the controller/processor and interface. As is known, a consumer already hooks-up a gas dryer to an electric power supply since the dryer does not typically operate on gas alone but the electrical connection is not for use as the heater to elevate the temperature of the circulated air in the drum, but the electricity powers the motors, controller, light, etc. However, a hook-up to will be necessary to operate coils for electrical heating of an existing gas dryer.

In summary, a hardwire connection or wireless connection can be made with a module, for example one located adjacent the clothes washer and clothes dryer. Such a module would interact with one or both of a washer and dryer and receive the signal from either a utility or a sub-division transmitter, or a module in the home or provided on the appliance that receives the signal. The module will send a signal, typically a wired signal to the washer and dryer or individually to the appliance, depending on whether there is a single home module for every appliance that controls home energy management or whether there is a module for each appliance in the home. Alternatively, such as the washer and dryer combination, one module may serve multiple appliances due to their proximity. There will also be the ability for the appliance to return a signal to the module if so desired.

The dryer could use electricity or combustible fuel or gas as the heater source, or both in a particular cycle. Alternatively, the dryer could use electrical heater(s) or a gas heater, or both, at different times or at different portions of the cycles. That is, the selection of the heater source need not be limited to a selection that is made at the beginning (or end) of a cycle only. It is also contemplated that the dryer could switch back and forth during the middle of a cycle with the controller determining the most efficient manner in order to switch from one fuel source or mode to another. For example, it may take longer to dry clothes under one suggested operation cycle but would still be more economical with one particular type of heater. It is further believed that monitoring the data and interrogating the cost/operational source during operation of the dryer can lead to a more cost-effective operation of the clothes dryer.

The disclosure has been described with reference to the preferred embodiments. Obviously, modifications and alterations will occur to others upon reading and understanding the preceding detailed description. It is intended that the disclosure be construed as including all such modifications and alterations.

What is claimed is:

1. A clothes dryer that operates on at least one of first and second heaters, the clothes dryer comprising:
a housing having a cavity for receiving associated laundry;
an air assembly for selectively circulating air into the cavity for drying the associated laundry; and
the air assembly configured for operative connection with a first heater and different type, second heater.

2. The clothes dryer of claim 1 wherein the first heater is an electrical heater and the second heater is a combustible gas heater.

3. The clothes dryer of claim 2 wherein the air assembly communicates with both the electrical heater and the combustible heater upstream of the cavity.

4. The clothes dryer of claim 1 further comprising a controller adapted to receive operational cost data from an associated external source.

5. The clothes dryer of claim 4 further comprising a user interface that displays operational information and includes an input portion allowing a consumer to select at least one operational parameter.

6. The dryer of claim 1 further comprising a controller configured to receive data from an associated first data source external to the drier regarding cost of the associated electrical source.

7. The dryer of claim 6 wherein the controller is further configured to receive data from an associated second data source external to the drier regarding cost of the associated combustible fuel source.

8. The dryer of claim 7 wherein the controller compares cost data from the associated first and second data sources and provides an output signal to operate the dryer at least in part from one of the associated first and second heaters.

9. The dryer of claim 6 wherein the controller compares cost data from the associated first and second external data sources and provides an output to the controller to select one of the first and second sources.

10. The dryer of claim 1 further comprising an electrical interface configured for connection with an associated electrical source, and a gas interface configured for connection with the associated combustible gas source.

11. The dryer of claim 1 wherein the second heater is a combustible gas heater that further includes a gas intake, gas valve, and a combustion chamber/burner.

12. The dryer of claim 11 wherein the first heater is an electrical resistance heater that further includes at least one electrical heater coil.

13. The dryer of claim 1 wherein the first heater is an electrical resistance heater that further includes at least one electrical heater coil.

14. A clothes dryer that operates on at least one of first and second heaters, the clothes dryer comprising:
a housing having a cavity for receiving associated laundry;
an air assembly for selectively circulating air into the cavity for drying the associated laundry;
an electrical heater and a combustible gas heater configured for operative connection with the air assembly; and
controller adapted to receive operational cost data from an associated external source, the controller providing for at least one of automated operation of the dryer in the most economical manner based on the operational cost data.

15. The clothes dryer of claim 14 further comprising a user interface operatively associated with the controller for displaying operational information and including an input portion allowing a consumer to select at least one operational parameter.

16. The clothes dryer of claim 14 wherein the first heater is an electrical resistance heater that further includes at least one electrical heater coil.

17. The clothes dryer of claim 14 wherein the second heater is a combustible gas heater that further includes a gas intake, gas valve, and a combustion chamber/burner.

18. A method of operating a clothes dryer having controller in communication with a first heater and a different type of second heater comprising:
inputting data from an associated source external to the dryer relating to operational cost to the controller; and
providing a user with a choice of operating the dryer in accordance with a routine suggested by the controller in response to the input data.

19. The method of claim 18 further comprising selecting at least one of the first and second heaters to heat the dryer.

20. The method of claim 19 further comprising periodically interrogating the associated external source for operational cost data.
